(19) United States
(12) Patent Application Publication
(10) Pub. No.: US 2003/0197092 A1
(43) Pub. Date: Oct. 23, 2003

(54) Speed regulated model airplane with double motor

(76) Inventors: Yu Tian, Shanghai (CN); Wenyan Jiang, Shanghai (CN)

Correspondence Address: RABIN & BERDO, P.C., Suite 500, 1101 14th Street, N.W., Washington, DC, 20005, US

(21) Appl. No.: 10/390,035

(22) Filed: Mar. 18, 2003

(30) Foreign Application Priority Data
Apr. 22, 2002 (CN) ZL 02216984.9

(51) Int. Cl. B64C 27/82; B64C 15/00

(52) U.S. Cl. 244/51

(57) ABSTRACT

A speed regulated model airplane with double motor comprising a fuselage, a wing, a tail pale, a tail and a remote controller, wherein: a left cowling and a right cowling are hanged separately on the both ends of a connecting rod crossing said fuselage to contain each an individual motor for driving left propeller and right propeller respectively; an RF signal receiving and processing and motor driving circuit and a battery are arranged beneath a hatch cover of said fuselage; said RF signal receiving and processing and motor driving circuit is operative to activate a clockwise (or anticlockwise) rotation of left propeller and an anticlockwise (or clockwise) rotation of right propeller under the control by said remote controller; and said wing is substantially in a horizontal line shape and located on the top of said fuselage.

### FIELD OF THE INVENTION

The utility model relates to a model airplane and in particular, to a speed regulated model airplane with double motor.

### BACKGROUND OF THE RELATED ART

Nowadays, the existing double motor type remote model airplane without speed regulation has some shortcomings as follows:

1. its wings are extended from the middle of fuselage, and the plane's center of gravity is high to cause stability inadequacy thereof;

2. the Plane is controlled by a switch from a remote controller to regulate its speed in step so that the operability is inadequate; and

3. the motors driving the propellers to propel the plane are rotating in same direction so that there should be an off-course during flying inherently.

### SUMMARY OF THE INVENTION

In view of the above problems, a model airplane (MP) according to the utility model is directed to:

1. obtain a MP flying in straight line without off-course;

2. improve the operability of MP; and

3. improve the security and stability of MP.

As a result, a speed regulated MP with double motor is provided with the features of stepless speed regulation, better operability, efficient control for straight line flying, better control for radius of turning and good stability.

Thus, the solution for a MP of the utility mode is given below.

According to the utility model, a speed regulated MP with double motor comprising a fuselage, a wing, a tail pole, a tail and a remote controller is mainly improved in that:

(1) a left cowling and a right cowling are hanged separately on the both ends of a connecting rod crossing said fuselage to contain each an individual motor for driving left propeller and right propeller respectively;

(2) an RF signal receiving and processing and motor driving circuit and a battery are arranged beneath a hatch cover of said fuselage;

(3) said RF signal receiving and processing and motor driving circuit is operative to activate a clockwise (or anticlockwise) rotation of left propeller and an anticlockwise (or clockwise) rotation of right propeller under the control by said remote controller; and

(4) said wing is substantially in a horizontal line shape and located on the top of said fuselage.

Said motor is a stepless speed regulated (SSR) motor;

Said tail is in a “V” shape; and

Said tail is a “⊥” shape tail composed of a vertical fin and a horizontal fin.

According to the utility model, the improvements of the speed regulated MP with double motor are as follows:

1. the plane can be balanced easily to prevent from directional drift during flying since two propellers are located of the both sides of fuselage respectively and rotated in opposite direction such that the torques generated by two motors are cancelled out because they are opposed to each other;

2. the stepless speed regulation is used in both motors to facilitate the operation for accurately controlling the turning radius of plane and provide better operability for flying in course correctly; and

3. the wing is located on the top of fuselage to form a high stage of wing, and thus the plane's center of gravity is low to give a desirable self-recovery and stability.

### BRIEF DESCRIPTION OF THE DRAWINGS

FIG. 1 is a schematic view showing the solid outline of a speed regulated MP with double motor (“⊥” shape tail) in embodiment 1 according to the utility model;

FIG. 2 is a schematic view showing the solid outline of a speed regulated MP with double motor (“V” shape tail) in embodiment 2 according to the utility model;

FIG. 3 is a schematic view showing the outline of remote controller in a speed regulated MP with double motor according to the utility model; and

FIG. 4 is a diagram of ED pulse waveform transmitted from the antenna of remote controller in a speed regulated MP with double motor according to the utility model;

Wherein: 1-fuselage, 2-wing, 3-tail pole, 4-tail; 11-carriage, 12-left propeller, 13-left cowling, 14-connecting rod, 15-right cowling, 16-right propeller, 17-hatch cover, 5-remote controller, 51-left joystick, 52-right joystick, 53-transmission antenna.

### DESCRIPTION OF PREFERRED EMBODIMENTS

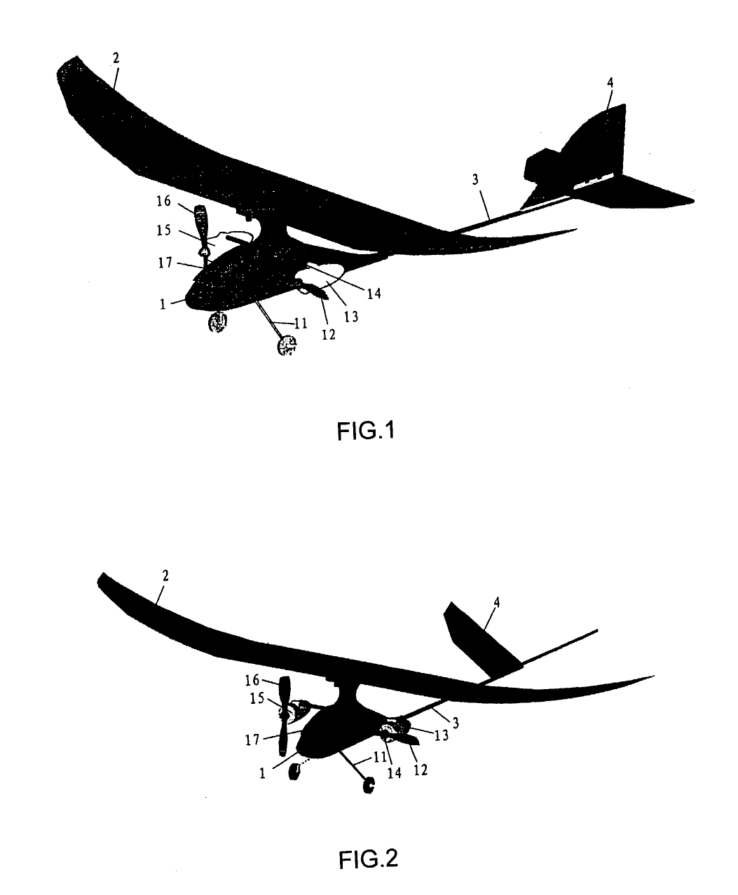

Please referring FIGS. 1 to 3, a speed regulated MP with double motor in accordance with utility model comprising a fuselage 1, a wing 2, a tail pole 3, a tail 4 and a remote controller 5 is characterized in that:

1. a left cowling 13 and a right cowling 15 are hanged separately on the both ends of a connecting rod 14 crossing the fuselage 1 to contain each an individual motor (not shown) for driving left propeller 12 and right propeller 16 respectively;

2. an RF signal receiving and processing and motor driving circuit and a battery are arranged beneath a hatch cover 17 of the fuselage 1; under the control of remote controller 5, RF signal transmitted from Tx.antenna 53 in remote controller 5 based on the operations of left and fight joysticks 51 and 52 is received by a RF signal receiver in the fuselage 1 and, after performing an appropriate operation, entered to two channel driving circuits to drive the respective motor to activate the left and right propellers for rotating in a direction opposed to each other;

3. said wing 2 is in a horizontal line shape and located on the top fuselage 1 with its high position to form a high stage of wing;

4. said motor is a stepless speed regulating motor;

5. said tail 4 of the plane may be either a “V” shape tail (as shown in FIG. 2) or a “⊥” shape tail composed of a horizontal fin and a vertical fin (as shown in FIG. 1); and

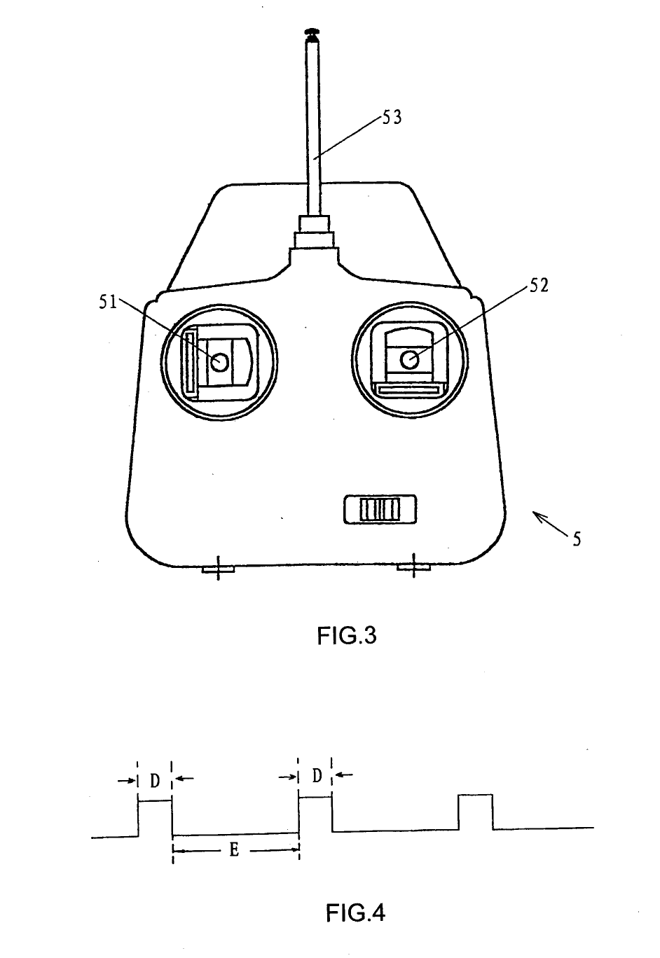

6. a typical exterior structure of the remote controller 5 is shown as FIG. 3, although other appearances can be taken for it of course, the basic structure thereof should comprise a left joystick 51, a right joystick 52 and a Tx.antenna 53.

Now, the operation principle and basic processes will be described in below for the NP in accordance with the utility model.

The internal configuration of remote controller 5 is well known in the prior art. However, it should be noted that the signal E sent by left joystick 51 has a same effect on two motors, while the function of signal D sent from right joystick 52 is different for them.

Let E be the signal sent from left joystick 51, and D be the signal sent from right joystick 52, then they are mixed to form the ED pulses as shown in FIG. 4 and transmitted by Tx.antenna 53 with RF carrier. The EF pulse signal is received by Rec.antenna in the fuselage 1, and passes the L and R channels to drive respective left and fight motors to rotate left propeller 12 and right propeller 16 respectively.

Left rotation speed L=(E−15)10+[(D−1.7)/0.5]×50%

Right rotation speed R=(E−15)/10+[(1.7−D)/0.5]×50%

The left joystick 51 can be pushed up continuously from the middle (E=15) to the top (E=25).

The right joystick 52 can operative to move from the leftmost point (D=1.2) to the rightmost point (D=2.2) through the middle (D=1.7) continuously.

It can be seen from the formulas given above that:

When E=15 and D=1.7, the plane will be static;

When D=1.7 and the left joystick 51 is being pushed upward from the middle, the flying of plane will start, and the two propellers of plane will be in same rotation speed, but their rotation directions are opposed with one in clockwise and another in anticlockwise to cancel out torques generated by two motors by their opposite relation so that the self-turning due to the own movement of plane will be eliminated, and thus the plane will be flying straightly forward in full speed, e.i.L=R=1, if the left joystick 51 is pushed up to the top to give E=25.

Furthermore, in case of E=25 and pushing the right joystick 52 from middle to left,

When D<1.7, then

L=1+[−X]×50% (speed-down)

R=1+[X]×50% (speed-up),

to obtain left turn of plane;

When D=1.2, then

L=1−[0.5/0.5]×50%=0.5 (speed-down)

R=1+[0.5/0.5]×50%=1.5 (speed-up),

to obtain the fastest left turn of plane;

When D>1.7, then

L=1+[X]×50% (speed-up)

R=1−[X]×50% (speed-down),

to obtain right turn of plane;

When D=2.2, then

L=1+[0.5/0.5]×50%=1.5 (speed-up),

R=1−[0.5/0.5]×50%=0.5 (speed-down)

to obtain the fastest right turn of plane; and

in case of E>15, when D<1.7, the plane will turn to left; and when D>1.7, the plane will turn to right.

The MP can be operated arbitrarily to make a turn or straight flying in flexible since the left and right joysticks 51 and 51 can be adjusted continuously supported by the stepless speed regulated motors.

Of E=15 and D=1.7, that is both joysticks resting in the respective middle, then the motors will stop, and the MP will land to ground naturally.

As the descriptions given above, it should be obviously that the advantages of the speed regulated MP with double motor according the utility model are as follows:

1. the plane can be balanced easily to prevent from directional drift during flying since two propellers are located of the both sides of fuselage respectively and rotated in opposite direction such that the torques generated by two motors are cancelled out because they are opposed to each other;

2. the stepless speed regulation is used in both motors to facilitate the operation for accurately controlling the turning radius of plane and provide better operability for flying in course correctly; and

3. the wing is located on the top of fuselage to form a high stage of wing, and thus the plane's center of gravity is low to give a desirable self-recovery and stability.

Although various embodiments of the utility model have hereinbefore been disclosed and described, the utility model is nonetheless limited only by the following claims.

1. A speed regulated model airplane with double motor comprising a fuselage (1), a wing (2), a tail pole (3), a tail (4) and a remote controller (5), wherein:
(1) a left cowling (13) and a right cowling (15) are hanged separately on the both ends of a connecting rod (14) crossing said fuselage (1) to contain each an individual motor for driving left propeller (12) and right propeller (16) respectively;
(2) an RF signal receiving and processing and motor driving circuit and a battery are arranged beneath a hatch cover (17) of said fuselage (1);
(3) said RF signal receiving and processing and motor driving circuit is operative to activate a clockwise (or anticlockwise) rotation of left propeller (12) and an anticlockwise (or clockwise) rotation of right propeller (16) under the control by said remote controller (5); and
(4) said wing (2) is substantially in a horizontal line shape and located on the top of said fuselage (1).

2. The speed regulated model airplane with double motor according to claim 1, wherein said motor is a stepless speed regulating motor.

3. The speed regulated model airplane with double motor according to claim 1, wherein said tail (4) is in a “V” shape.

4. The speed regulated model airplane with double motor according to claim 1, wherein said tail (4) is a “⊥” shape tail composed of a vertical fin and a horizontal fin.

5. The speed regulated model airplane with double motor according to claim 2, wherein said tail (4) is in a “V” shape.

6. The speed regulated model airplane with double motor according to claim 2, wherein said tail (4) is a “⊥” shape tail composed of a vertical fin and a horizontal fin.
